(19) United States
(12) Patent Application Publication
(10) Pub. No.: US 2002/0053583 A1
(43) Pub. Date: May 9, 2002

(54) MOTORCYCLE PACK WITH INTEGRAL SUPPORT STRUCTURE, AND ATTACHMENT SYSTEM FOR MODULAR BAGS

(76) Inventor: MICHAEL ALDRICH, PINEDALE, WY (US)

Correspondence Address: DAVID W O'BRYANT, MORRISS BATEMAN O'BRYANT & COMPAGNI, 5882 SOUTH 900 EAST, SUITE 300, SALT LAKE CITY, UT, 84121

(21) Appl. No.: 09/258,172

(22) Filed: Feb. 25, 1999

(51) Int. Cl. B62J 7/00; B62J 9/00; B62J 11/00

(52) U.S. Cl. 224/413; 224/427

(57) ABSTRACT

A method and apparatus for providing a main pack including a slidably adjustable attachment system for securing the main pack to any size backrest of a motorcycle, a built-in support structure in a bottom panel which prevents the bottom panel from obscuring a motorcycle's tail lights, and a plurality of conveniently located attachment devices on the main pack for safely and conveniently securing a plurality of different size bags thereto.

### BACKGROUND

1. The Field of the Invention.

This invention relates generally to a pack which can be mounted on a motorcycle. More specifically, the invention relates to a modular and adjustable pack that is mounted to the frame of a motorcycle, wherein the pack includes an attachment system that is able to adjust to different size support frames of motorcycles, a unique support system that prevents the pack from obscuring the motorcycle's tail lights, and an attachment system whereby modular bags can be easily and securely coupled to the pack for customization thereof without using loose straps or cords that can become loose and fall into a rear wheel.

2. The State of the Art

The advantageous features of the present invention are specifically designed to overcome the significant shortcomings of the state of the art in motorcycle packs. For example, a disadvantage of some packs is that they are not easily attached to the large variety of different motorcycle frames that are currently in use. Typically, a motorcycle pack is coupled to a backrest or sissy bar. Unfortunately, backrests come in many different lengths and widths. Furthermore, some motorcycles only have a single post backrest. Many packs are thus only attachable to the backrest using bungie cords or ropes. Bungie cords are not only inconvenient to use, they are dangerous on motorcycles as evidenced by the accidents that they have caused. For example, they can work loose and become entangled in a rear wheel. Accordingly, what is needed is a universal attachment system which enables a pack to be securely and conveniently coupled to a backrest, regardless of its dimensions.

Another disadvantage of some packs is that they have a tendency to sag at the bottom. Because a pack is coupled to the backrest, the pack is typically disposed over the tail lights. This problem is illustrated in FIGS. 1A and 1B. FIG. 1A is an elevational profile view of the rear of a motorcycle 14 having a pack 10 coupled to a backrest 18. FIG. 1B is an elevational view of the pack 10 and the rear of the motorcycle 14 as seen from the perspective A-A shown in FIG. 1A.

FIGS. 1A and 1B show that a sagging pack 10 can obscure the tail lights 12 of the motorcycle 14, preventing drivers behind the motorcycle from seeing it clearly at night, or from having as much warning as possible when the motorcyclist brakes or signals a turn. This obscuring of the tail lights 12 can happen regardless of the support rack 16 that is typically disposed over a rear fender assembly 19. Accordingly, it would be an advantage over the state of the art to provide a pack that does not inhibit the view of tail lights 12, regardless of how it is loaded onto the motorcycle.

Another disadvantage of some state of the art packs is that there is no adequate protection against the elements. Rain protection typically comprises trash bags that are somehow wrapped around a pack. The trash bags easily tear, and do not conform to the packs. Some attempts have been made at providing a more durable cover made from the same material as the pack. Unfortunately, it is typically inadequate because the cover cannot be adjusted to properly fit a pack that has other items strapped to the sides, front or top. Furthermore, rain is typically driven into and through the seams of prior art durable covers, allowing the pack and its contents to still get wet.

Accordingly, it would be advantageous to provide a weather cover which is easily adjusted to the size of the pack, including any attachments such as modular bags. It would also be advantageous to prevent water from being driven into and through seams of the weather cover.

Another disadvantage of some packs is that they are designed to be modular or easily customizable to the requirements of the user. Thus, when other bags are coupled to a main pack, the only method of attachment is to use bungie cords or other straps that can work loose.

The packs are typically of two different designs. FIG. 2 shows the first design where the pack 20 is made with many different zippered pouches 22 on the sides or the front of the pack 20. While this design may have its uses, there is no way to remove the pouches 22 if they are not needed. Furthermore, the pouches 22 are disadvantageously covered up by other items that are strapped to the pack 20 and which do not fit within the pouches 22. For example, a tent bag 24 and a smaller utility bag 26 are shown disposed along the sides of the pack 20. Access to the pouches 22 is then restricted because of bungie cords 28 or other straps being used to secure the tent bag 24 and the smaller utility bag 26. It is therefore likely to be difficult to access the pouches 22 without removing the other bags 24, 26 that are strapped on to the main pack 20.

The second prior art design shown in FIG. 3 is where the pack 30 is made without the zippered pouches, but still without any means for safely securing additional items 32 to the pack 30. Just as with the pack shown in FIG. 2, people will strap the additional items 32 to the outside of the main pack 30 using bungie cords, or as in this case, nylon straps with adjustable buckles 34. Disadvantageously, the buckled straps 34 can shift because they are not securely attached to the pack 30 itself. Furthermore, bungie cords and buckled straps can make access to the pack 30 or to other items attached to the pack difficult because the straps 34 may go around the entire pack.

It is observed that even if a person is able to get access to the zippered pouches 22 of FIG. 2, or to the pack 30 of FIG. 3 without removing the attachment straps 34, removing items can result in the straps or other attachment cords becoming loose. The user is thus required to retighten the straps 34 in order to prevent attached items from working loose and falling off the pack 30.

Accordingly, it would advantageous to provide a pack that had a safe and secure means of attaching modular bags to the main pack that would allow access to the pack and to the modular bags at any time. It would be advantageous to avoid readjustment of the means for attaching additional bags to the main pack, regardless of what might be removed or added to the main pack 30 or to other bags. It would also be advantageous to avoid the use of attaching means that can work loose and dangle near the rear wheel of the motorcycle.

### OBJECTS AND SUMMARY OF THE INVENTION

It is an object of the present invention to provide a method and apparatus for coupling a main pack to any size backrest of a motorcycle.

It is another object to provide a method and apparatus for providing an attachment system for coupling the main pack to the backrest which is slidably adjustable for securely coupling the main pack to the backrest.

It is another object to provide a method and apparatus for safely and conveniently coupling a plurality of modular bags to the main pack without the use of loose cords.

It is another object to provide a method and apparatus for coupling the plurality of modular bags of different sizes to the main pack such that the plurality of modular bags can be coupled to the main pack at interchangeable locations.

It is another object to provide a method and apparatus for coupling the plurality of modular bags to the main pack such that they do not interfere with access to other bags or the main pack, or require adjustment if items are removed or added to the main pack or other bags.

It is another object to provide a method and apparatus for preventing the main pack or any attached bags from interfering with tail lights on a motorcycle.

It is another object to provide a method and apparatus for weatherproofing the main pack and any attached bags.

It is another object to provide a method and apparatus for eliminating dangerous ropes, bungie cords or other loose straps when coupling the plurality of bags to the main pack.

The presently preferred embodiment of the present invention is a main pack including a slidably adjustable attachment system for securing the main pack to any size backrest of a motorcycle, a built-in support structure in a bottom panel of the main pack which prevents the bottom panel from sagging and obscuring a motorcycle's tail lights, and a plurality of conveniently located attachment devices on the main pack for safely and conveniently securing a plurality of different size bags thereto.

In a first aspect of the invention, the attachment system for securing the main pack to the backrest of the motorcycle comprises a slidably adjustable system which is able to conform to a wide range of backrest heights, widths and configurations.

In a second aspect of the invention, the bottom panel of the main pack includes at least one rigid yet flexible fiberglass rod which prevents the bottom panel from sagging over the tail lights.

In a third aspect of the invention, a system of conveniently located clips located on the main pack enables quick and easy attachment and removal of differently sized bags.

In a fourth aspect of the invention, a weather cover is designed to protect seams from the inflow of rain. The weather cover can also be resized to cover the main pack with and without bags.

These and other objects, features, advantages and alternative aspects of the present invention will become apparent to those skilled in the art from a consideration of the following detailed description taken in combination with the accompanying drawings.

### BRIEF DESCRIPTION OF THE DRAWINGS

FIG. 1A is an elevational profile illustration of the prior art where a pack is coupled to a backrest of a motorcycle and disposed on a support rack disposed over a fender assembly, obscuring the tail lights because there is no support structure in bottom portion of a pack.

FIG. 1B is a rear elevational profile view of the prior art and shown along the perspective A-A as shown in FIG. 1A.

FIG. 2 is an elevational profile illustration of the prior art where a pack to be mounted on a motorcycle is shown having a plurality of zippered pouches which are integral to the structure of the pack, and utility bags that are strapped to the pack using bungie cords.

FIG. 3 is an elevational profile illustration of the prior art where a pack to be mounted on a motorcycle is shown without zippered pouches, but with utility bags strapped to the pack using straps with buckles.

FIG. 4 is a perspective illustration of the presently preferred embodiment made in accordance with the principles of the present invention, wherein the pack is shown having a plurality of attachment devices for safely and conveniently securing modular utility bags to the main pack.

FIG. 5A is a perspective illustration of a modular bag being coupled using the integral attachment devices to the top panel of the main pack.

FIG. 5B is a side elevational profile view of the modular bag and main pack shown in FIG. 5A, and which illustrates how the coupling devices secure the modular bag to the main pack.

FIG. 6 is a close-up top view illustration of one of the plurality of coupling devices, consisting of a receiving end and an attaching end.

FIG. 7A is a perspective illustration of a bottom panel of the main pack having a plurality of rod holders for holding fiberglass rods which prevent the bottom panel from sagging over the tail lights.

FIG. 7B is a close-up of a portion of the drawing shown in FIG. 7A, providing additional detail of an insertable rod, a flap for closing the rod holder, and stitching on the rod holder to create a tube-like structure for the rod.

FIG. 7C is provided as an elevational rear view similar to FIG. 1B but which shows how the integral support rods prevent the main pack from covering the tail lights.

FIG. 7D is an alternative embodiment showing three rods inserted in the bottom panel of the main pack.

FIG. 7E is another alternative embodiment showing a single rod inserted into the bottom panel of the main pack.

FIG. 7F is another alternative embodiment showing a mesh that is inserted into the bottom panel of the main pack.

FIG. 8A is an elevational profile view of a base mechanism coupled to a track that is disposed vertically along a back face of the main pack. Straps are coupled to the base mechanism and are secured to a motorcycle backrest.

FIG. 8B is an elevational perspective view of the base mechanism and the straps that are coupled to the backrest.

FIG. 8C is an elevational profile view of the attachment system coupled to a backrest.

FIG. 9 is an elevational front face view of a weather cover as used in the presently preferred embodiment.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It is useful to have an overview of the present invention before delving into the detailed description of the preferred embodiment. Accordingly, it is observed that the present invention advantageously provides features of greater durability, more secure attachment to a motorcycle, improved coupling of various utility bags to a main pack to achieve greater flexibility of use and modularity in design, improved safety by ensuring that the tail lights remain visible, and that there are no attachment straps that can work loose or fall off, and improved weatherproofing. These features will be explained in the following disclosure.

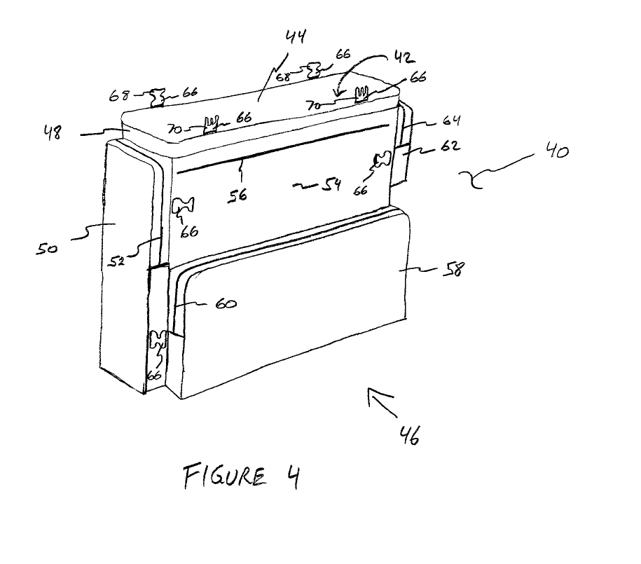

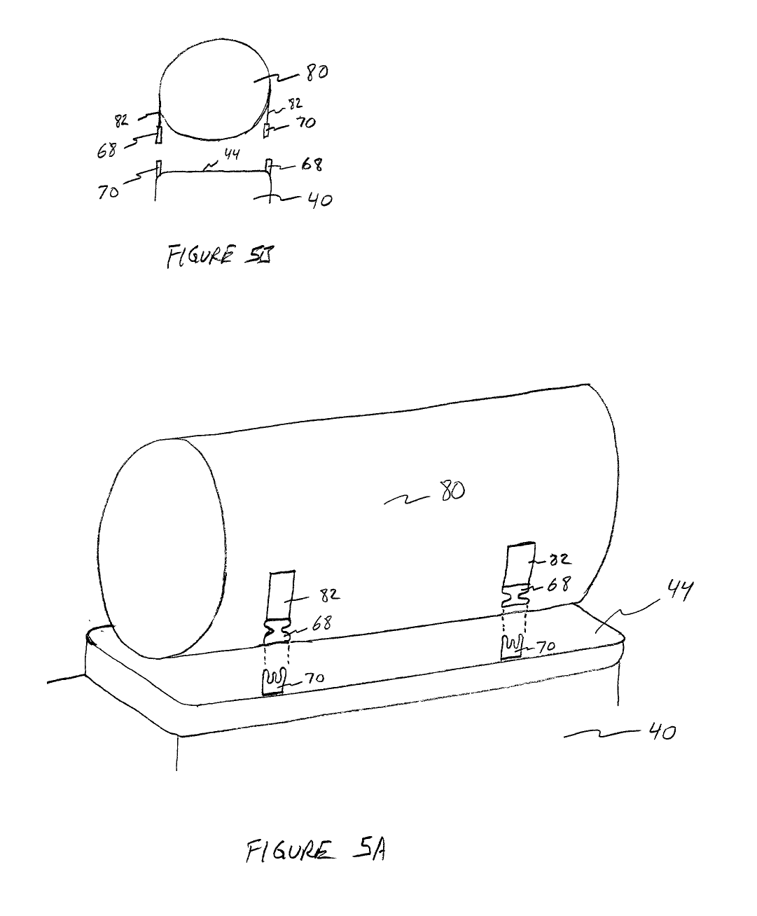

FIG. 4 is a perspective illustration of the presently preferred embodiment of the main pack 40 that is made in accordance with the principles of the present invention. The main pack 40 is shown from a front perspective, where the front 46 faces rearwardly when the main pack 40 is mounted on a motorcycle. The main pack 40 consists of five enclosed storage chambers, and a bottle holder on the bottom right side.

A primary storage chamber 42 is accessed through a top access panel 44. The top access panel 44 has a flap 48 around a top edge which covers a zipper underneath. The zipper extends all the way around the right, front, and left top edges of the main pack 40.

The left side of the main pack 40 has an integral storage chamber 50 that extends from the top edge of the main pack 40 to the bottom edge. A zipper 52 is disposed along a top edge and partially down a front side of the integral storage chamber 50.

The front of the main pack 40 has two integral storage chambers. A first front storage chamber 54 is constructed as a flat pocket, without any inherent volume to the chamber. It is useful, for example, for holding papers such as maps. The first front storage chamber 54 is accessed via a zipper 56.

A second front storage chamber 58 is constructed as a long chamber which extends along the width of the main pack 40, and is approximately half the height. The second front storage chamber 58 is accessed via a zipper 60 that extends partially down a right side edge, a left side edge, and all the way along a top edge.

The right side of the main pack 40 has an integral storage chamber 62 that extends from approximately the top edge of the main pack 40 to approximately half way down the height of the main pack. A zipper 64 is disposed along a top edge and partially down a front side of the integral storage chamber 62.

The bottle holder 72 is a feature that is not visible in this perspective view. It will be illustrated fully in another figure.

A first novel feature of the plurality of novel features of the preferred embodiment that is visible in FIG. 4 are the plurality of coupling devices 66 that are strategically disposed around the main pack 40. Some of the coupling devices 66 are receiving devices 68, and some are attaching devices 70. An example of two of each type of coupling device 68 is illustrated on the top access panel 44 of the main pack 40.

It is observed that the exact placement of the coupling devices 68 can vary from that shown. What is important to remember is that the coupling devices need to be sufficiently spaced apart so as to spread the load among them so as to not overly stress any single coupling device. It is also important to remember that a receiving device 68 can often be switched with an attaching device 70, especially when the coupling devices are used to couple a same bag to the main pack 40.

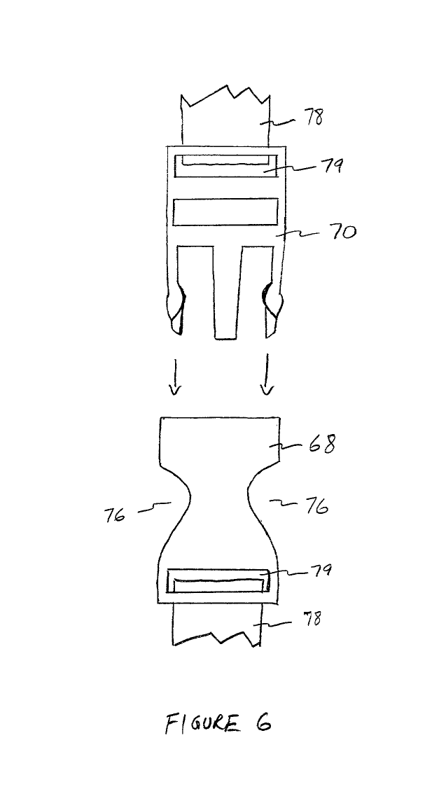

FIG. 5A is provided as an illustration of how the coupling devices 66 are used to safely secure a bag to the main pack 40 without the use of bungie cords or other loose straps. In this figure, a sleeping bag has been stuffed into a round storage bag 80. The storage bag 80 has the same type of coupling devices 66 that are on the main pack 40, and which are spaced so as to match up with complementary receiving devices 68 and attaching devices 70 on the main pack.

FIG. 5A is a close-up perspective view of the top access panel 44 and the storage bag 80. The figure shows that the storage bag 80 has two receiving devices 68 on the ends of two nylon straps 82 that are sewn onto the sleeping bag. The storage bag 80 is simply pressed against the top access panel 44 while the attaching devices 70 are slipped into the complementary receiving devices 68.

Advantageously, the storage bag 80 is not coupled to the main pack 40 using any loose straps. Furthermore, access to other integral storage chambers of the main pack is not restricted. Even the top access panel 44 can be unzipped to allow access to the primary storage chamber 42. It is also noted that bags made of other shapes can be just as easily and conveniently coupled to the main pack using the coupling devices 66.

FIG. 5B is provided as an end-on elevational profile view of the storage bag 80, the main pack 40, and the coupling devices 68, 70. It is noted that one side of the storage bag 80 is shown with attaching devices 70, and the other side with receiving devices 68. This choice is arbitrary. It does serve the purpose of making storage bags couple to the main pack in only one direction. This can be useful if one side of a storage bag, for example, has special weather protection. However, it should be apparent that the storage bags that are manufactured to be coupled to the main pack 40 have all been outfitted with the appropriate coupling devices 66.

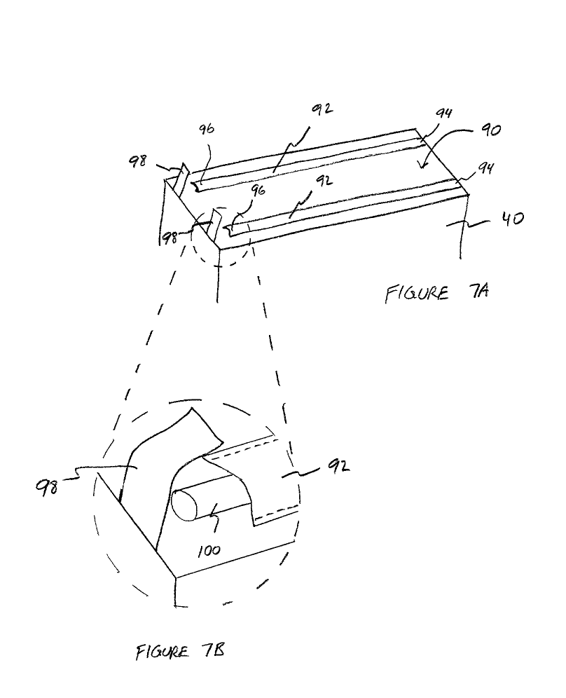

FIG. 6 is provided as a close-up top elevational view of the coupling devices 66 that are used in the presently preferred embodiment. The type of coupling devices 66 selected for use in the preferred embodiment were chosen, among other things, for their ease of operation and durability. An attaching device 70 is easily inserted into a receiving device 68. It is then a one-handed operation to simultaneously squeeze the sides of the attaching device inwards at the indentations 76 on the sides of the receiving device 68, thereby releasing the attaching device 70 from the receiving device 68. The coupling devices are secured to the main pack 40 or to a modular bag using nylon straps of adjustable length. The nylon straps are typically sewn directly onto the coupling devices at holes 79 disposed in a non-attachment end thereof.

The coupling devices 66 are familiar to many people, as they are commonly found on such devices as lap belts in a baby stroller, etc. It is observed that the exact type of coupling device can be replaced with any other design which provides the same advantages as do those used in the preferred embodiment. Specifically, that is easy coupling and decoupling, and durability.

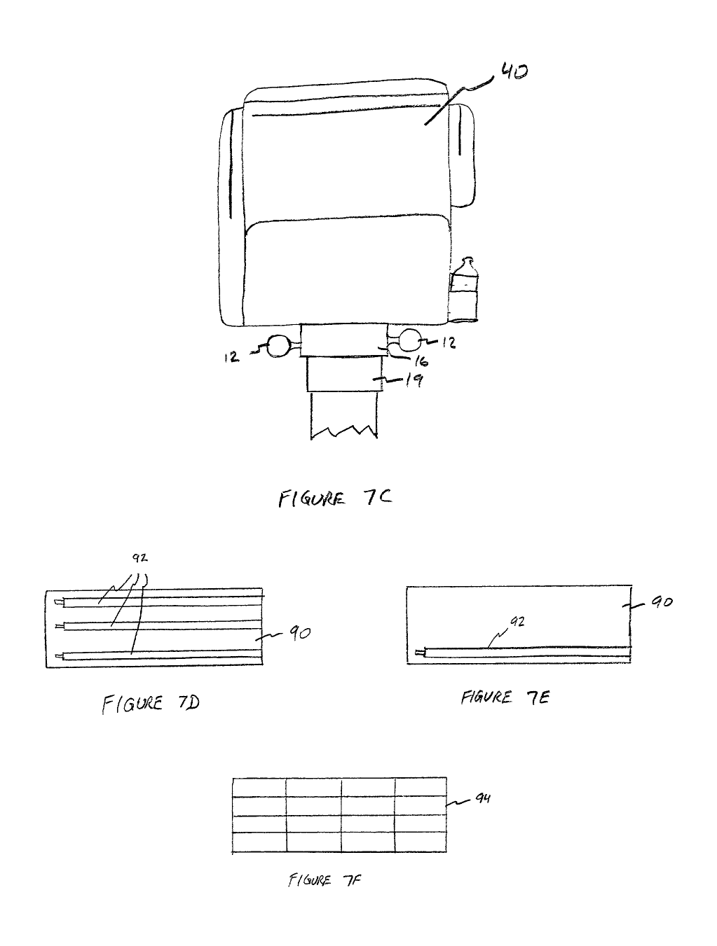

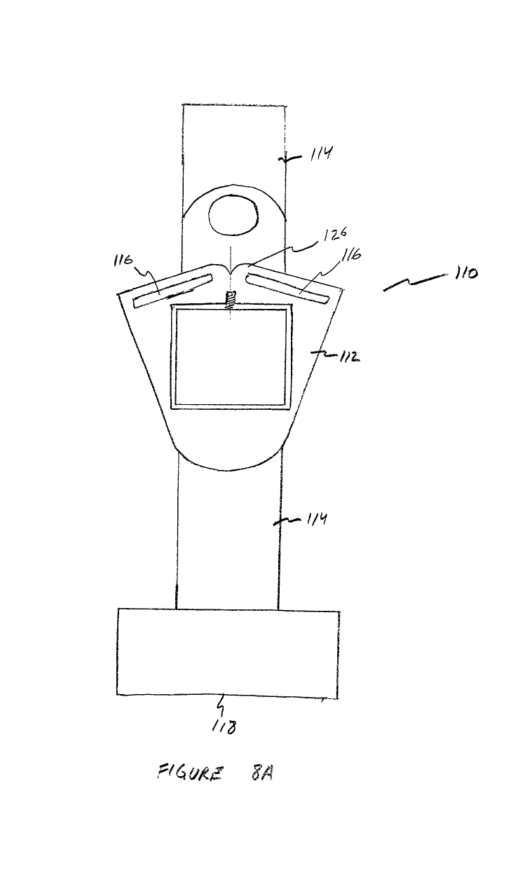

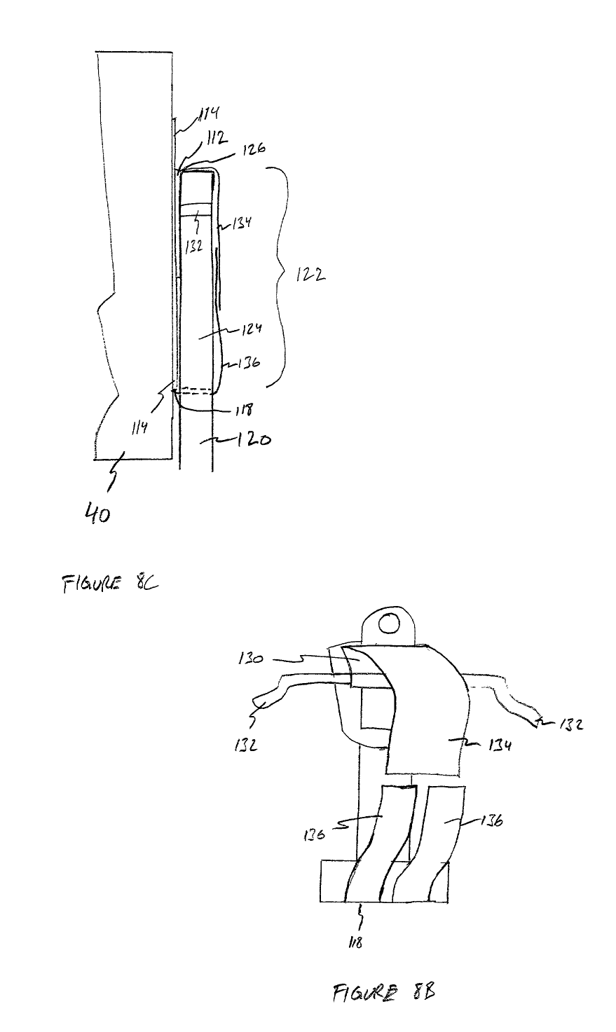

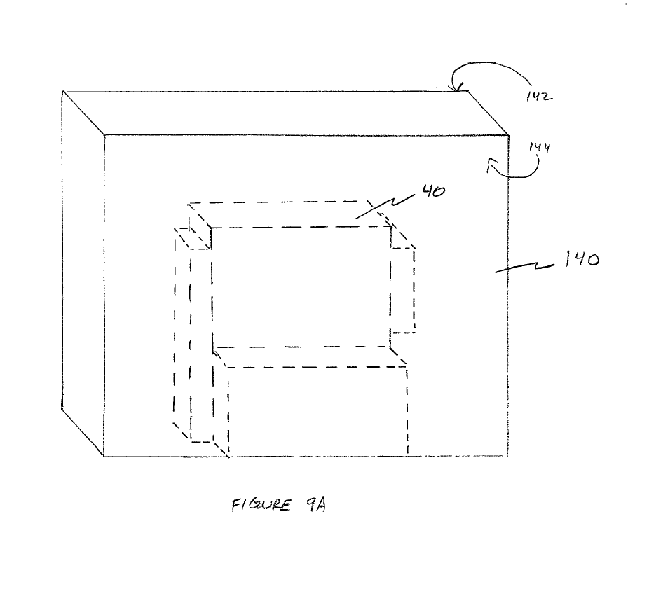

FIG. 7A is provided to illustrate another novel feature of the presently preferred embodiment. Disposed underneath a bottom panel 90 of the main pack 40 are a plurality of rod holders 92 that are constructed from a durable material that is sewn to the underside of the bottom panel 90. A tube-like structure is created from the durable material by sewing along each of the outer edges. The rod holders 92 are constructed with a first end 94 that is sealed, typically by sewing it shut, to prevent a rod that is inserted into the rod holder 92 from falling out. A second end 96 of the rod holder 92 is left open so that a rod can be inserted therein. The second end 96 can be closed using flaps 98 that folder over the second end. In this presently preferred embodiment, the flaps 98 are secured to the second end 96 using velcro.

FIG. 7B illustrates more clearly that the rod holders 92 are constructed such that a rod 100 inserted therein can be removed. This may be important if the rod 100 were to break and require replacement. However, it is noted that the rod 100 utilized in the presently preferred embodiment is composed of fiberglass, making it durable and yet flexible enough to be able to give under tension.

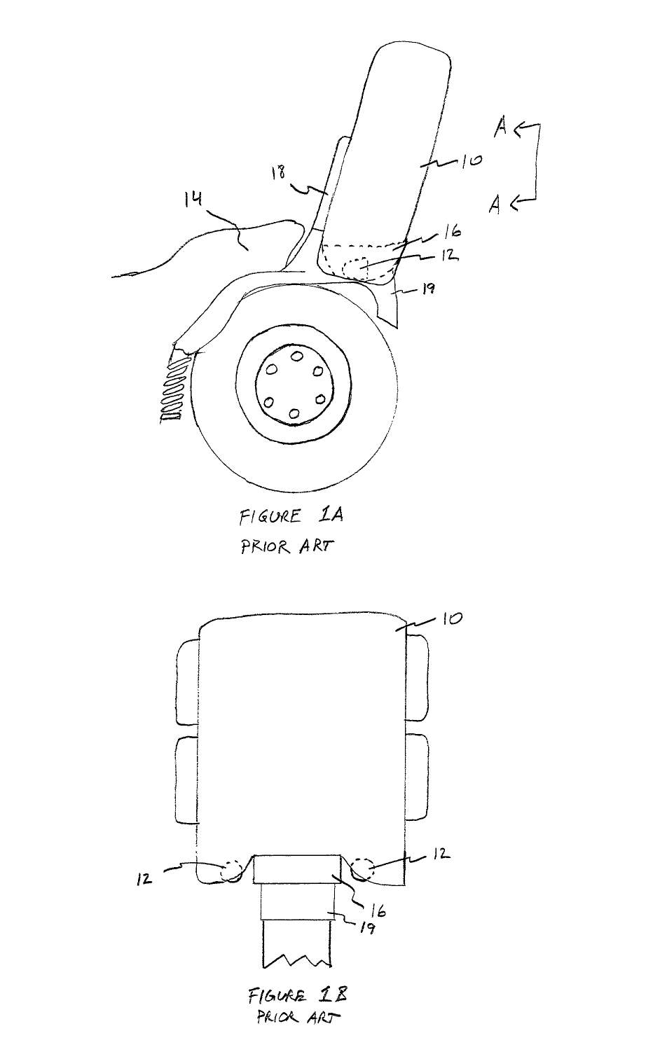

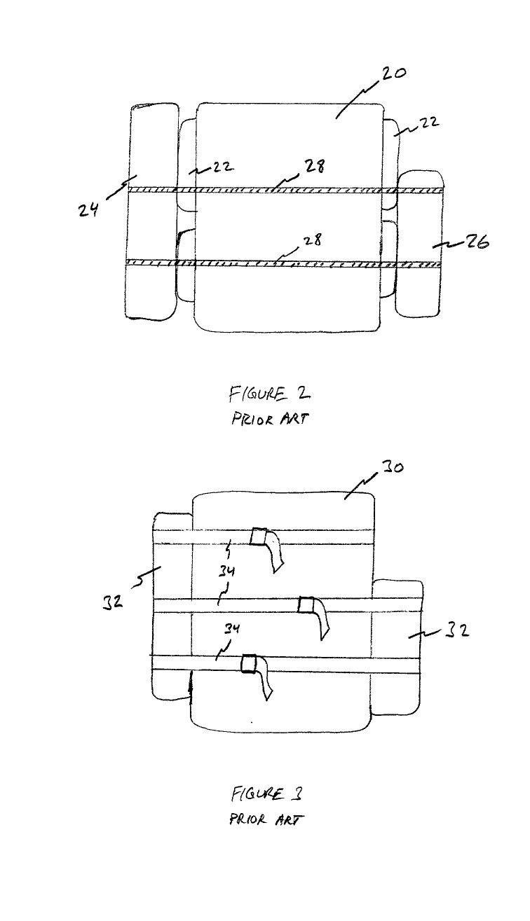

FIG. 7C is provided as an elevational rear view illustration of the motorcycle similar to FIG. 1B, but which shows how the integral support rods 100 prevent the main pack 40 from covering the tail lights 12.

The presently preferred embodiment shows that two rods are disposed in the bottom panel of the main pack. This appears to be an optimum configuration in terms of weight and for preventing any portion of the bottom panel from sagging over the tail lights. It also has the advantage of keeping the main pack lightweight.

FIG. 7D, however, shows that in a first alternative embodiment, a greater number of rods can be used for additional support. FIG. 7E shows in another alternative embodiment that a single rod can be used. The single rod can be disposed towards a middle of the bottom panel, toward a front end as shown, or toward a back end of the main pack. In another alternative embodiment, different materials can be used for the rods. Instead of fiberglass, metal or plastic can be substituted. In addition, the rod can be replaced with other configurations. For example, FIG. 7F shows that a mesh-like grid 94 can be disposed in the bottom panel 90. The grid 94 can be constructed of metal or a resilient and durable yet flexible plastic.

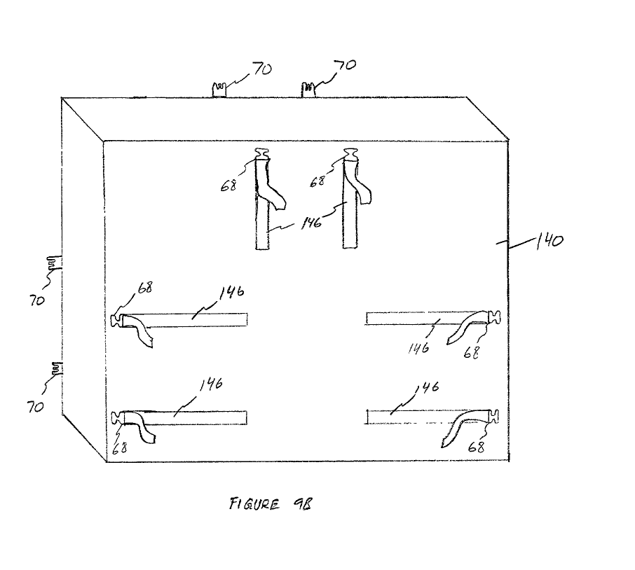

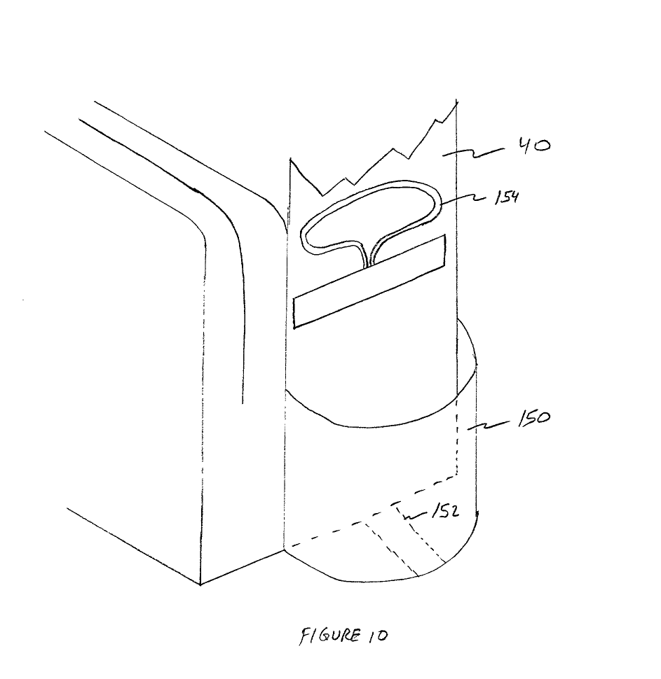

FIG. 8 is a perspective illustration of the attachment mechanism being used to couple the pack to motorcycle backrests of various sizes and configurations. It is noted from the outset that the attachment mechanism is only novel in its application to the present invention. In other words, the attachment mechanism is adapted from its intended, and is now used for securing the main pack to a motorcycle backrest.

For example, an attachment mechanism such as the one described in U.S. Pat. No. 4,860,936 can be used to secure the main pack 40 to a motorcycle backrest. The attachment mechanism 110 is characterized by a slidable base member 112 having a structure for securing it to a pack 40. The base member 112 is disposed so as to slide along a track 114 of a relatively thick and durable nylon material. Holes 116 for securing backpack straps to the base member 112 are also provided. The base member 112 also includes a locking structure (on a backside of the base member 112) for releasably securing the base member 112 to the track 114. The movable base member 112 can move along the track 114 and resecured along the track at any of a number of positions by releasing and securing the locking structure.

FIG. 8B is provided as an elevational perspective view of the attachment system straps. A first flap 130 extends down behind a backrest, and is secured to the backrest using straps 132. The straps 132 are secured to each other using velcro in this preferred embodiment. A second flap 134 extends over and down the backrest where is meets two straps 136 which extend upwards to meet and couple to the second flap 134. A large portion of an underside of the second flap 134 is covered with velcro material. This enables the straps 134, 136 to adjust to many different heights of motorcycle backrests.

FIG. 8C is provided as an elevational side view of how the attachment system is used to securely and adjustable secure the main pack 40 to a motorcycle backrest 120. In this preferred embodiment, the attachment system is able to adjust to the height 122 of a pad 124 disposed in the backrest 120. This is accomplished by sliding the base member 112 along the track 114 until a base 118 of the track 114 is at the bottom of the pad 124, and a top 126 of the base member 112 is a top of the pad 124. The straps 132 extend around the pad 124, the second flap 134 extends down and over the pad, and the straps 136 extend under and upwards around the pad to be secured the second flap.

It should be apparent that modifications to the attachment system can be made which will still enable it to conform to variously sized motorcycle backrests. These alternative arrangements should also be considered to be within the scope of the claims below.

As was mentioned previously, a weather cover is provided to prevent moisture from seeping into the main pack. FIG. 9 is an elevational perspective view which shows an approximate size of the weather cover 140. The relative size of the main pack 40 without attached modular bags is shown in dotted lines within the weather cover 140. It should be apparent that the dimensions of the weather cover exceed those of the main pack 40 in all directions. Obviously, in this form, the weather cover 140 is not useful. Accordingly, a plurality of straps and coupling devices are provided on the weather cover 140 so that it can be cinched tight around the main pack 40, in accordance with the number and shape of utility bags that are coupled to the main pack 40.

One of the important features of the weather cover 140 which is not immediately apparent is that it is designed so that a back face 142 covers the back face of the main pack 140, and that a front face 144 covers the front face of the main pack 40. All seams and loose overlapping material of the weather cover 140 are on the front face 144 or are facing forward. No seams are present on the back face 142. This is done to prevent precipitation that will be driven against the back face 142 from seeping through to the main pack 40 within.

The presently preferred embodiment of the weather cover 140 utilizes coupling devices that are comprised of attachment devices 70 and receiving devices 68. In this embodiment, it was arbitrarily decided to dispose the attaching devices 70 directly onto the weather cover 140. The receiving devices 68 are disposed on the ends of nylon straps 146, where the nylon straps are sewn onto the weather cover 140. Sufficient nylon strap material is provided on the nylon straps 146 such that it is possible to have the weather cover 140 almost extend to its maximum dimensions. After the weather is pulled up and over the main pack 40, the complementary attaching and receiving devices are coupled, and the nylon straps 146 cinched tightly. The nylon straps 146 are tightened by pulling on a loose end which is threaded through a looping end of the receiving devices 68.

It is important to realize that the weather cover can be constructed using various placements of coupling devices and nylon straps. What is important to remember is that the seams be directed as much as possible away from the back face 142, and that the folds and flaps of extra material be directed forwards toward the front face 144, along a direction of air flow over the weather cover. This will help the weather cover to resist seepage of precipitation through the seams.

Finally, FIG. 10 is provided as another view of the presently preferred embodiment. Specifically, FIG. 10 is provided as a close-up perspective view of the right side of the main pack 40, similar to the view shown in FIG. 4 from the left side perspective. This figure is being provided in order to show a rounded pocket 150 sewn on the bottom right side of the main pack 40. The pocket 150 is best suited to receive a rounded bottle or other rounded container such as a water bottle. A bottom of the pocket 150 is simply comprised of a strap shown in outline through the sides of the pocket 150. This allows precipitation to freely drain out of the pocket 150, even when a container is disposed within the pocket 150. An elastic strap 154 is also disposed above the pocket 150, and which can be placed about an upper portion of the rounded container to thereby hold it securely into the pocket by the elastic tension.

Although the features are not patentable, it is also disclosed herein that a material used in construction of the pack, the modular storage bags that are coupled thereto, and the weather cover, is preferably comprised of CORDURA (TM), a durable and generally water-resistant material that is manufactured in several different colors. Any other suitable material having properties that are similar to CORDURA (TM) can be substituted.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A pack for use with a motorcycle, wherein the pack is securely coupled to a frame of the motorcycle, regardless of dimensions of a backrest to which the pack is coupled, said pack comprising:
a pack having a front face, a back face, a top panel, a bottom panel, a left side, and a right side; and
an attachment mechanism that is disposed on the back face of the pack, wherein the attachment mechanism is an integral unit that is characterized by having all straps having at least one end sewn into the integral unit, wherein the attachment mechanism further comprises:
a base member which is coupled to the back face of the pack;
a first flap which is coupled to a top portion of a base member, such that the first flap is disposed over a top portion of a stationary object and partially down a length thereof; and
a second flap which is coupled to a bottom portion of the attachment mechanism, and disposed under a bottom portion of the stationary object and partially up a length thereof, and wherein the first flap is coupled to the second flap to thereby enclose a portion of the stationary object between the first flap, the second flap, and the back face.

2. The pack as defined in claim 1 wherein the attachment mechanism further comprises a third flap, wherein the third flap is coupled to the top portion of the base member, and extends partially down a length of the stationary object between the stationary object and the back face.

3. The pack as defined in claim 2 wherein the third flap further comprises a first strap and a second strap, wherein the first strap and the second strap are disposed generally horizontally around the stationary object and are secured together to provide more stability to the pack.

4. The pack as defined in claim 1 wherein the attachment mechanism further comprises:
a vertical track which is centered in the middle of the back face, said track comprised of a durable material that is sewn to the pack along a centerline thereof; and
a track guide having a cross section of a loop having a gap therein, wherein the track guide is partially disposed about the track such that the track guide is slidably coupled thereto, thereby enabling the track guide to move up and down a length thereof, and wherein the track guide is integrally coupled to the base member.

5. The pack as defined in claim 1 wherein the attachment mechanism further comprises a means for preventing slidable movement of the base member up and down the vertical track, to thereby secure the pack to the stationary object.

6. The pack as defined in claim 1 wherein the pack is further comprised of a plurality of coupling devices, said coupling devices provided for securing objects directly to the pack without having to use other means of securing objects to the pack.

7. The pack as defined in claim 6 wherein the plurality of coupling devices further comprises:
a plurality of attaching devices which are disposed on the pack, wherein the plurality of attaching devices are prepared for attaching to a plurality of complementary receiving devices disposed on the objects to be secured directly to the pack; and
a plurality of receiving devices which are disposed on the pack, wherein the plurality of receiving devices are prepared for receiving a plurality of complementary attaching devices disposed on the objects to be secured directly to the pack.

8. The pack as defined in claim 7 wherein the plurality of coupling devices are secured to the main pack via an attaching end having a loop therein, wherein a strap extends from a seam of the pack, passes through the loop, and extends back to the seam, wherein stitching of the seam holds secure both ends of the strap.

9. The pack as defined in claim 8 wherein each of the plurality of attaching devices are coupled to each of the plurality of receiving devices by partially sliding thereinto until at least one depressable edge in each of the plurality of receiving devices is caught by a corresponding catch in each of the plurality of receiving devices, wherein the edge engaging the catch prevents backwards movement of each of the plurality of attaching devices, and wherein depressing the at least one depressable edge enables the plurality of receiving devices to decouple from the at least one attaching devices.

10. The pack as defined in claim 1 wherein the bottom panel further comprises at least one rod holder, wherein said rod holder is disposed generally along the width of the pack, wherein a flexible yet resilient rod is inserted into the rod holder, and wherein the presence of the rod in the rod holder is characterized by resisting downward movement of the right side and the left side of the bottom panel relative to a center of the bottom panel.

11. The pack as defined in claim 10 wherein the bottom further comprises two rod holders, wherein a first rod holder is disposed adjacent to and parallel with the front face, and wherein a second rod holder is disposed adjacent to and parallel with the back face.

12. The pack as defined in claim 10 wherein the rod is further comprised of fiberglass, thereby enabling the rod to flex while resisting downward movement of the right side and the left side of the pack.

13. The pack as defined in claim 10 wherein the at least one rod holder is comprised of a strip of material which is sewn lengthwise in two parallel lines to the bottom panel, wherein the rod is disposed between the two parallel sewing lines, wherein the rod holder is sewn shut at a first end, and wherein a strap of material is folded and secured over a second end where the rod is inserted into the at least one rod holder.

14. The pack as defined in claim 1 wherein the bottom panel further comprises a flexible and yet resilient material forming a mesh which is coupled to the bottom panel, wherein the mesh resists downward movement of the right side and the left side of the bottom panel relative to a center of the bottom panel.

15. A pack as defined in claim 1 wherein the pack further a weather covering, wherein the weather covering comprises:
a covering which is disposed over the pack so as to cover the top panel, the front face, the back face, the top panel, the left side, and the right side, and any other objects which are coupled to the pack, and wherein seams of the covering are folded towards the front face to prevent seepage of water therethrough; and
a plurality of coupling devices disposed so as to enable the covering to be held against the pack, and to prevent any extra material of the covering from enabling water to collect and pass through the seams of the covering.

16. The pack as defined in claim 15 wherein the plurality of coupling devices are integral to the covering, and wherein they are disposed in complementary pairs of attaching and receiving devices, having a strap coupled to at least one of each of the complementary pairs, wherein the strap is coupled at a first end to the covering, and wherein the strap can be tightened to thereby enable the covering to expand or contract around the pack as necessary.

17. A method of providing a pack which is adjustably disposable to a stationary object on a motorcycle, wherein the method comprises the steps of:
(1) providing a pack having a front face, a back face, a top panel, a bottom panel, a left side, and a right side;
(2) disposing an attachment mechanism on the back face of the pack, wherein the attachment mechanism is slidably movable on the back face;
(3) pulling a first flap over and partially down the stationary object;
(4) pulling a second flap under and partially up the stationary object; and
(5) coupling the first flap to the second flap.

18. The method as defined in claim 17 wherein the method further comprises preventing the pack from obscuring tail lights on the motorcycle, said method comprising the steps of disposing at least one flexible and yet resilient rod into the bottom panel, parallel to the front face, to thereby inhibit downward movement of the right side or the left side of bottom panel.

19. The method as defined in claim 17 wherein the method further comprises the step of coupling additional storage bags to the pack, without having to use cords or other non-integral straps that can work loose, said method comprising the steps of:
(1) providing a plurality of coupling devices for the pack; and
(2) disposing the plurality of coupling devices along seams thereof, wherein the coupling devices are comprised of a plurality attaching devices, and a plurality of receiving devices, wherein the plurality of receiving devices of the pack receive complementary attaching devices of the additional storage bags, and wherein the plurality of attaching devices of the pack receive complementary receiving devices of the additional storage bags.

20. The method as defined in claim 19 wherein the method further comprises the step of providing a plurality of adjustable straps that are integral to the coupling devices, such that adjustments can be made to a tension applied to the additional storage bags.
